(19) United States
(12) Patent Application Publication
(10) Pub. No.: US 2022/0277144 A1
(43) Pub. Date: Sep. 1, 2022

(54) WORD EMBEDDING VECTOR INTEGRATION DEVICE, WORD EMBEDDING VECTOR INTEGRATION METHOD, AND WORD EMBEDDING VECTOR INTEGRATION PROGRAM

(71) Applicant: NIPPON TELEGRAPH AND TELEPHONE CORPORATION, Tokyo (JP)

(72) Inventors: Tsutomu HIRAO, Tokyo (JP); Masaaki NAGATA, Tokyo (JP); Katsuhiko HAYASHI, Tokyo (JP)

(73) Assignee: NIPPON TELEGRAPH AND TELEPHONE CORPORATION, Tokyo (JP)

(21) Appl. No.: 17/620,680

(22) PCT Filed: Jun. 15, 2020
(86) PCT No.: PCT/JP2020/023370

§ 371 Date: Dec. 18, 2021

(30) Foreign Application Priority Data
Jun. 19, 2019 (JP) 2019-113682

(51) Int. Cl. G06F 40/30; G06F 40/279; G06F 40/216

(52) U.S. Cl. CPC G06F 40/30; G06F 40/279; G06F 40/216

(57) ABSTRACT

To make it possible to efficiently learn word embedding vectors of respective words contained in two corpora.

A basis vector correspondence determination unit 22 determines correspondence between basis vectors obtained from word embedding vectors of respective words generated from a corpus A and basis vectors obtained from word embedding vectors of respective words generated from a corpus B. Based on the determined correspondence, a word embedding vector integration unit 24 changes the word embedding vectors of the respective words contained in the corpus B so as to rearrange elements of the word embedding vectors of the respective words contained in the corpus B.

### TECHNICAL FIELD

The present disclosure relates to a word embedding vector integration apparatus, a word embedding vector integration method, and a word embedding vector integration program.

### BACKGROUND ART

A word embedding vector is a technique for expressing a word as a vector of a fixed dimension and various vectorization techniques have been proposed. Specifically, the word embedding vector can be obtained by using a technique (e.g., Singular Value Decomposition (SVD) or Nonnegative Matrix Factorization (NMF)) that uses matrix decomposition or by using a topic model such as LDA. However, these techniques take calculation time, and thus Word2Vec (Non-Patent Literature 1) or GloVe (Non-Patent Literature 2) has been in common use recently.

### CITATION LIST

### Non-Patent Literature

Non-Patent Literature 1: Tomas Mikolov, and Ilya Sutskever and Kai Chen and Greg Corrado S and Jeff Dean, Jeff. 2013. “Distributed Representations of Words and Phrases and their Compositionality” In Proceedings of the Advances in Neural Information Processing Systems 26, pp. 3111-3119
Non-Patent Literature 2: Jeffrey Pennington, Richard Socher, and Christopher-Manning. 2014. “Glove: Global vectors for word representation.” In Proceedings of the 2014 Conference on Empirical Methods in Natural Language-Processing (EMNLP), pp. 1532-1543

### SUMMARY OF THE INVENTION

### Technical Problem

Learning intended to obtain a word embedding vector is done with respect to a large-scale corpus. Thus, after a word embedding vector is learned once, if one attempts to add a word embedding vector of a new word, it becomes necessary to prepare a new corpus including the word, combine the corpus used before and the new corpus into a single corpus, and relearn a word embedding vector. Also, in an attempt to add a word of a language different from that of the word embedding vector learned before, even if a word vector is learned by creating a corpus by putting the two languages together, the learning itself will not work well from the beginning.

A disclosed technique has been worked out in view of the above point and has an object to provide a word embedding vector integration apparatus, a word embedding vector integration method, and a word embedding vector integration program that can efficiently learn word embedding vectors of respective words in two corpora.

### Means for Solving the Problem

A first aspect of the present disclosure is a word embedding vector integration apparatus, comprising: a basis vector correspondence determination unit; and a word embedding vector integration unit wherein: the basis vector correspondence determination unit determines correspondence between basis vectors obtained from word embedding vectors of respective words generated from a corpus A and contained in the corpus A, each of the basis vectors being made up of a value of a same element of the word embedding vectors of the respective words, and basis vectors obtained from word embedding vectors of respective words generated from a corpus B different from the corpus A and contained in the corpus B, each of the basis vectors being made up of a value of a same element of the word embedding vectors of the respective words, the correspondence being determined based on the word embedding vectors of the respective words contained in the corpus A and on the word embedding vectors of the respective words contained in the corpus B; and the word embedding vector integration unit changes the word embedding vectors of the respective words contained in the corpus B based on the determined correspondence so as to rearrange elements of the word embedding vectors of the respective words contained in the corpus B.

A second aspect of the present disclosure is a word embedding vector integration method, whereby: a basis vector correspondence determination unit determines correspondence between basis vectors obtained from word embedding vectors of respective words generated from a corpus A and contained in the corpus A, each of the basis vectors being made up of a value of a same element of the word embedding vectors of the respective words, and basis vectors obtained from word embedding vectors of respective words generated from a corpus B different from the corpus A and contained in the corpus B, each of the basis vectors being made up of a value of a same element of the word embedding vectors of the respective words, the correspondence being determined based on the word embedding vectors of the respective words contained in the corpus A and on the word embedding vectors of the respective words contained in the corpus B; and a word embedding vector integration unit changes the word embedding vectors of the respective words contained in the corpus B based on the determined correspondence so as to rearrange elements of the word embedding vectors of the respective words contained in the corpus B.

A third aspect of the present disclosure is a word embedding vector integration program that causes a computer: to determine correspondence between basis vectors obtained from word embedding vectors of respective words generated from a corpus A and contained in the corpus A, each of the basis vectors being made up of a value of a same element of the word embedding vectors of the respective words, and basis vectors obtained from word embedding vectors of respective words generated from a corpus B different from the corpus A and contained in the corpus B, each of the basis vectors being made up of a value of a same element of the word embedding vectors of the respective words, the correspondence being determined based on the word embedding vectors of the respective words contained in the corpus A and on the word embedding vectors of the respective words contained in the corpus B; and to change the word embedding vectors of the respective words contained in the corpus B based on the determined correspondence so as to rearrange elements of the word embedding vectors of the respective words contained in the corpus B.

### Effects of the Invention

The disclosed technique makes it possible to efficiently learn the word embedding vectors of the respective words contained in two corpora.

### BRIEF DESCRIPTION OF DRAWINGS

FIG. 1 is a schematic block diagram of an exemplary computer functioning as a word embedding vector integration apparatus according to the present embodiment.

FIG. 2 is a block diagram showing a configuration of the word embedding vector integration apparatus according to the present embodiment.

FIG. 3 is a diagram for explaining a process of a word embedding vector generation unit.

FIG. 4 is a diagram for explaining a process of a basis vector correspondence determination unit.

FIG. 5 is a diagram for explaining a method for rearranging elements of a word embedding vector.

FIG. 6 is a flowchart showing a word embedding vector integration process routine of the word embedding vector integration apparatus according to the present embodiment.

### DESCRIPTION OF EMBODIMENTS

An exemplary embodiment of the disclosed technique will be described below with reference to the drawings. Note that same or equivalent components and parts in different drawings are denoted by the same reference numerals. Also, size ratios in the drawings are exaggerated for convenience of explanation and may be different from actual size ratios.

### Configuration of Word Embedding Vector Integration Apparatus According to Present Embodiment

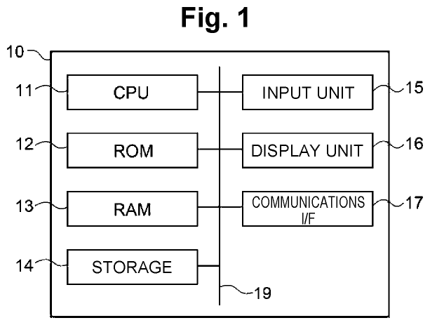

FIG. 1 is a block diagram showing a hardware configuration of a word embedding vector integration apparatus 10 according to the present embodiment.

As shown in FIG. 1, the word embedding vector integration apparatus 10 includes a CPU (Central Processing Unit) 11, a ROM (Read Only Memory) 12, a RAM (Random Access Memory) 13, a storage 14, an input unit 15, a display unit 16, and a communications interface (I/F) 17. These components are interconnected via a bus 19 in a communication-enabled state.

The CPU 11, which is a central processing unit, executes various programs and controls various parts. That is, the CPU 11 reads programs out of the ROM 12 or the storage 14 and executes the programs using the RAM 13 as a work area. The CPU 11 controls the above components and performs various computational processes according to the programs stored in the ROM 12 or the storage 14. According to the present embodiment, the ROM 12 or the storage 14 stores a word embedding vector integration program used to integrate word embedding vectors of two corpora. The word embedding vector integration program may be a single program or a program group made up of plural programs or modules.

The ROM 12 stores various programs and various data. The RAM 13, as a work area, temporarily stores programs or data. The storage 14 is made up of an HDD (Hard Disk Drive) or an SSD (Solid State Drive) and stores various programs including an operating system and various data.

The input unit 15 includes a pointing device such as a mouse as well as a keyboard and is used to enter various inputs.

The display unit 16 is, for example, a liquid crystal display, and displays various information. By adopting a touch panel scheme, the display unit 16 may function as the input unit 15.

The communications interface 17 is used to communicate with other devices, and conforms to standards such as Ethernet (registered trademark), FDDI, and Wi-Fi (registered trademark).

Next, a functional configuration of the word embedding vector integration apparatus 10 will be described.

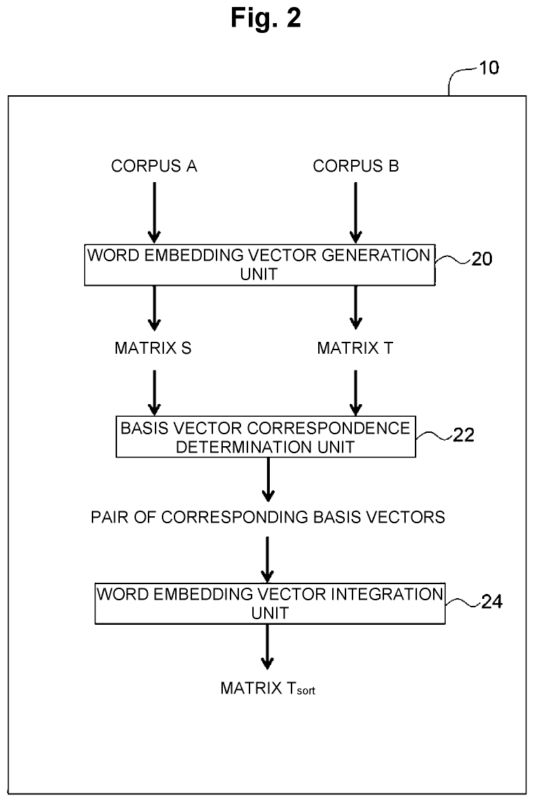

FIG. 2 is a block diagram showing an exemplary functional configuration of the word embedding vector integration apparatus 10.

As shown in FIG. 2, in terms of functional configuration, the word embedding vector integration apparatus 10 includes a word embedding vector generation unit 20, a basis vector correspondence determination unit 22, and a word embedding vector integration unit 24. The functional components are implemented as the word embedding vector integration program is read out of the ROM 12 or the storage 14, loaded into the RAM 13, and executed by the CPU 11.

The word embedding vector generation unit 20 receives a corpus A entered via the input unit 15, generates a word embedding vector set made up of word embedding vectors of respective words contained in the corpus A, and passes the set to the basis vector correspondence determination unit 22. Also, the word embedding vector generation unit 20 receives a corpus B entered via the input unit 15, the corpus B being different from the corpus A, generates a word embedding vector set made up of word embedding vectors of respective words contained in the corpus B, and passes the set to the basis vector correspondence determination unit 22.

Specifically, the word embedding vector generation unit 20 generates two different word embedding vector sets using the following procedures.

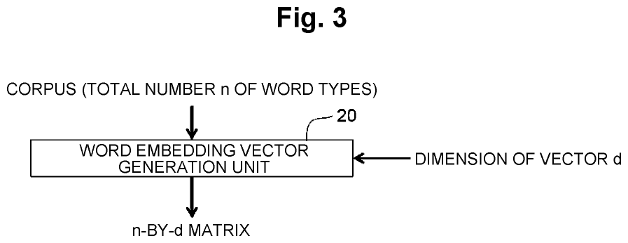

First, the word embedding vector generation unit 20 generates a word embedding vector set from the corpus A. It is assumed that the word embedding vectors are expressed as d-dimensional vectors and that the total number of word types in the corpus A is denoted by n (see FIG. 3). The total number of word types in the corpus A is the number of word types appearing in the corpus A. The word embedding vector set made up of the word embedding vectors of the respective words contained in the corpus A can be regarded as an n-by-d matrix, which is denoted by S. Next, the word embedding vector generation unit 20 generates a set of d-dimensional word embedding vectors using the other corpus B. Note that the total number of word types in the corpus B is denoted by m. The word embedding vector set made up of the word embedding vectors of the respective words contained in the corpus B can be regarded as an m-by-d matrix, which is denoted by T. In this way, the word embedding vector generation unit 20 generates the matrices S and T and passes the matrices to the basis vector correspondence determination unit 22. Existing techniques of Non-Patent Literature 1 or 2 can be used to generate word embedding vectors.

It is assumed that the corpus A and the corpus B differ from each other in language or domain.

Based on the matrix S that represents the word embedding vectors of the respective words contained in the corpus A and the matrix T that represents the word embedding vectors of the respective words contained in the corpus B, the basis vector correspondence determination unit 22 determines correspondence between basis vectors obtained as column vectors of the matrix S and each made up of a value of a same element of the word embedding vectors of the respective words and basis vectors obtained as column vectors of the matrix T and each made up of a value of a same element of the word embedding vectors of the respective words.

Specifically, the basis vector correspondence determination unit 22 determines correspondence between the basis vectors in the manner described below.

The i-th row vector S_{i,:} of the matrix S represents the i-th word embedding vector, and the j-th column vector S_{:,j} of the matrix S represents the j-th basis vector. Regarding the matrix T, again the row vector is the word embedding vector and the column vector is the basis vector. Since the number of basis vectors is d in both the matrix S and the matrix T, if a one-to-one correspondence between the matrix S and the matrix T can be established in terms of the number of basis vectors, the basis vectors correspond to each other between the two different matrices, making it possible to integrate the two word embedding vector sets. The one-to-one correspondence of the basis vectors can be established using an existing technique such as Matching CCA (Non-Patent Literature 3) or Kernelized Sotring (Non-Patent Literature 4).
[Non-Patent Literature 3] Aria Haghighiand Percy Liang and Taylor Berg-Kirkpatrick and Dan Klein, 2008, “Learning Bilingual Lexicons from Monolingual Cor-pora” In Proceedings of ACL-08:HLT, pp. 771-779
[Non-Patent Literature 4] Novi Quadrianto and Le Song and Alex J. Smola, 2009, “Kernelized Sorting” In Proceedings of the Advances in Neural Information Processing Systems 21

Note that in using Matching CCA or Kernelized Sorting, to obtain highly reliable correspondence, it is necessary to manually provide the correspondence of the basis vectors, which serves as a seed.

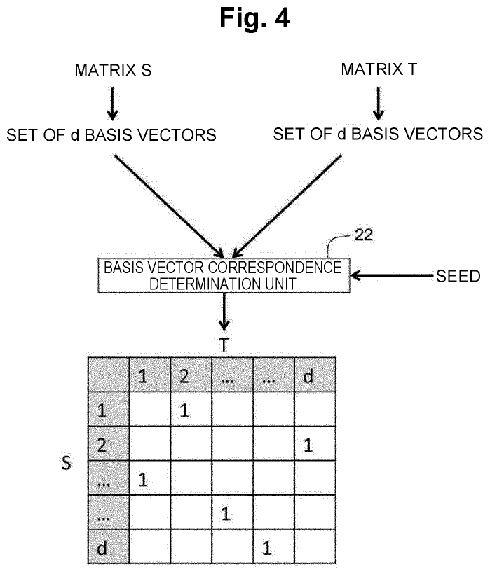

In this case, by presenting words related to the basis vectors corresponding to the word embedding vectors of the respective words contained in the corpus A and words related to the basis vectors corresponding to the word embedding vectors of the respective words contained in the corpus B, the basis vector correspondence determination unit 22 accepts the correspondence of the basis vectors. For example, of the words contained in the corpus A, the basis vector correspondence determination unit 22 presents k words whose elements corresponding to the basis vectors score high to a user in relation to each basis vector. Also, of the words contained in the corpus B, the basis vector correspondence determination unit 22 presents k words whose elements corresponding to the basis vectors score high to the user in relation to each basis vector. Then, the basis vector correspondence determination unit 22 accepts from the user the correspondence of basis vectors, of which meanings of related words are similar to each other, and thereby determines correspondence of the basis vectors, and then passes the correspondence of the basis vectors thus determined to the word embedding vector integration unit 24. A one-to-one correspondence can be expressed as shown in the table at the bottom of FIG. 4. However, when a given cell contains 1, no cell on the right, left, upper, or lower side of the given cell can contain 1.

The word embedding vector integration unit 24 receives the correspondence of the basis vectors, and changes the word embedding vectors of the respective words contained in the corpus B based on the correspondence, with the elements of the word embedding vectors in the corpus A fixed, so as to rearrange the elements of the word embedding vectors in the corpus B. This integrates the set of the word embedding vectors in the corpus A with the set of the word embedding vectors in the corpus B.

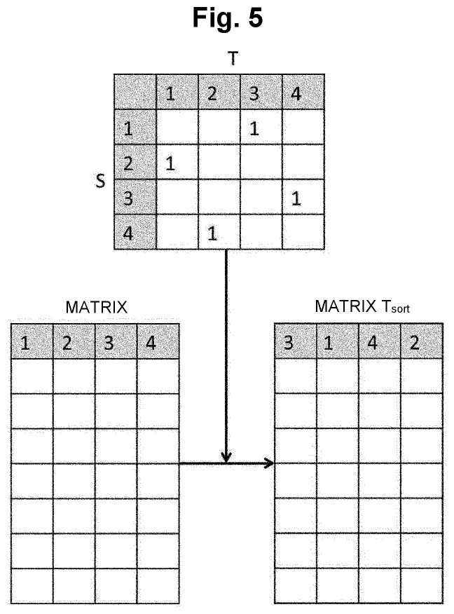

For example, if a correspondence of (S_{:,1}; T_{:,3}), (S_{:,2}; T_{:,1}), (S_{:,3}; T_{:,4}), and (S_{:,4}; T_{:,2}) is obtained as a correspondence of basis vectors, by rearranging the basis vectors of the matrix T and thereby obtaining Tₛₒᵣₜ=[T_{:,3}T_{:,1}T_{:,4}T_{:,2}] as shown in FIG. 5, the elements of the word embedding vectors in the corpus B are rearranged. In this way, when the correspondence of basis vectors is determined, any of the words contained in the corpora A and B come to exist in a same vector space. That is, sets of word embedding vectors independently obtained from different corpora can be mapped to the same space. Note that if a same word exists in the corpus A and the corpus B, a mean vector is used as an embedding vector of this word. Specifically, if there is a word common to the corpus A and the corpus B, the word embedding vector integration unit 24 uses a mean vector of the word embedding vector of the word in the corpus A and the changed word embedding vector of the word in the corpus B as a word embedding vector of the word.

### Working of Word Embedding Vector Integration Apparatus According to Present Embodiment

Next, working of the word embedding vector integration apparatus 10 will be described.

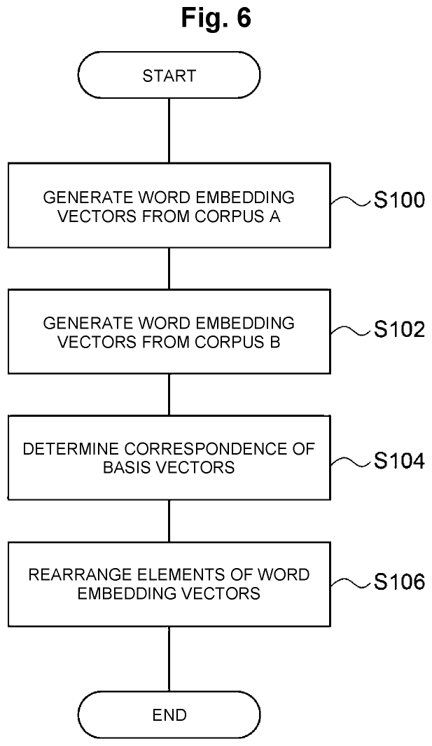

FIG. 6 is a flowchart showing a flow of a word embedding vector integration process performed by the word embedding vector integration apparatus 10. The word embedding vector integration process is performed as the word embedding vector integration program is read out of the ROM 12 or the storage 14, loaded into the RAM 13, and executed by the CPU 11.

In step S100, by acting as the word embedding vector generation unit 20, the CPU 11 receives the corpus A entered via the input unit 15 and generates a word embedding vector set made up of the word embedding vectors of the respective words contained in the corpus A.

In step S102, by acting as the word embedding vector generation unit 20, the CPU 11 receives the corpus B entered via the input unit 15 and generates a word embedding vector set made up of the word embedding vectors of the respective words contained in the corpus B.

In step S104, based on the matrix S that represents the word embedding vectors of the respective words contained in the corpus A and the matrix T that represents the word embedding vectors of the respective words contained in the corpus B, the CPU 11 acting as the basis vector correspondence determination unit 22 determines correspondence between the basis vectors obtained as column vectors of the matrix S and the basis vectors obtained as column vectors of the matrix T.

In step S106, by acting as the word embedding vector integration unit 24, the CPU 11 receives the correspondence of the basis vectors and changes the word embedding vectors of the respective words contained in the corpus B based on the correspondence, with the elements of the word embedding vectors in the corpus A fixed, so as to rearrange the elements of the word embedding vectors in the corpus B.

As has been described above, the word embedding vector integration apparatus according to the present embodiment determines the correspondence between the basis vectors obtained from the word embedding vectors of the respective words contained in the corpus A and the basis vectors obtained from the word embedding vectors of the respective words contained in the corpus B. Also, the word embedding vector integration apparatus changes the word embedding vectors of the respective words contained in the corpus B based on the determined correspondence so as to rearrange the elements of the word embedding vectors of the respective words contained in the corpus B. This makes it possible to efficiently learn the word embedding vectors of the respective words contained in the two corpora. In particular, after word embedding vectors in a corpus are learned once, the word embedding vectors can be learned such that new words will be added to the word embedding vectors regardless of the language.

Also, two sets of word embedding vectors created independently of each other can be integrated and treated as a single set of word embedding vectors. Since the word embedding vectors may be created independently, computational efficiency is increased. Also, because the corpora for use to create two word embedding vectors are not restricted in language or domain, it is possible to calculate similarity in words between different languages, calculate similarity in words between different domains of a same language, and so on.

Also, two word embedding vector sets learned independently of each other can be treated as a single word embedding vector set without relearning. Also, by establishing a one-to-one correspondence of the basis vectors of word embedding vectors obtained from two corpora, the word embedding vectors obtained from the two corpora can be integrated.

Note that the word embedding vector integration process performed by the CPU by reading software (program) in the above embodiments may be performed by any of various processors other than the CPU. In that case, examples of the processors include a PLD (Programmable Logic Device), such as a FPGA (Field-Programmable Gate Array), which lend themselves to changes in circuit configuration after manufacture, and a dedicated electric circuit, such as an ASIC (Application Specific Integrated Circuit), which is a processor having a circuit configuration exclusively designed to perform a specific process. Also, the word embedding vector integration process may be performed by one of the various processors or a combination of two or more processors of a same type or different types (e.g., plural FPGAs, a combination of the CPU and an FPGA). Also, hardware structures of the various processors, more specifically, are electric circuits made up of combinations of circuit elements such as semiconductor elements.

Also, in the above embodiments, description has been given of aspects in which the word embedding vector integration program has been stored (installed) in the storage 14 in advance, but this is not restrictive. The program may be provided in such a form as to be stored in a non-transitory storage medium such as a CD-ROM (Compact Disk Read Only Memory), a DVD-ROM (Digital Versatile Disk Read Only Memory), or a USB (Universal Serial Bus) memory. Also, the program may be provided in such a form as to be downloaded from an external device via a network.

Also, although description has been given by taking as an example a case in which the word embedding vector integration apparatus generates sets of word embedding vectors from corpora, this is not restrictive. A word embedding vector set generated from a corpus by an external device may be accepted as input.

The following addenda will be further disclosed regarding the above embodiment.

(Addendum 1)

A word embedding vector integration apparatus, comprising:

a memory; and

at least one processor connected to the memory, wherein

the processor is configured to:
determine correspondence between basis vectors obtained from word embedding vectors of respective words generated from a corpus A and contained in the corpus A, each of the basis vectors being made up of a value of a same element of the word embedding vectors of the respective words, and basis vectors obtained from word embedding vectors of respective words generated from a corpus B different from the corpus A and contained in the corpus B, each of the basis vectors being made up of a value of a same element of the word embedding vectors of the respective words, the correspondence being determined based on the word embedding vectors of the respective words contained in the corpus A and on the word embedding vectors of the respective words contained in the corpus B; and
change the word embedding vectors of the respective words contained in the corpus B based on the determined correspondence so as to rearrange elements of the word embedding vectors of the respective words contained in the corpus B.

(Addendum 2)

A non-transitory storage medium storing a computer-executable program so as to execute a word embedding vector integration process wherein:

the word embedding vector integration process:
determines correspondence between basis vectors obtained from word embedding vectors of respective words generated from a corpus A and contained in the corpus A, each of the basis vectors being made up of a value of a same element of the word embedding vectors of the respective words, and basis vectors obtained from word embedding vectors of respective words generated from a corpus B different from the corpus A and contained in the corpus B, each of the basis vectors being made up of a value of a same element of the word embedding vectors of the respective words, the correspondence being determined based on the word embedding vectors of the respective words contained in the corpus A and on the word embedding vectors of the respective words contained in the corpus B; and
changes the word embedding vectors of the respective words contained in the corpus B based on the determined correspondence so as to rearrange elements of the word embedding vectors of the respective words contained in the corpus B.

### REFERENCE SIGNS LIST

10 Word embedding vector integration apparatus
20 Word embedding vector generation unit
22 Basis vector correspondence determination unit
24 Word embedding vector integration unit

1. A word embedding vector integration apparatus comprising circuitry configured to execute a method comprising:
determining correspondence between basis vectors obtained from word embedding vectors of respective words generated from a first corpus and contained in the first corpus,
each of the basis vectors being made up of a value of a same element of the word embedding vectors of the respective words, and basis vectors obtained from word embedding vectors of respective words generated from a second corpus different from the first corpus and contained in the second corpus, each of the basis vectors being made up of a value of a same element of the word embedding vectors of the respective words, the correspondence being determined based on the word embedding vectors of the respective words contained in the first corpus and on the word embedding vectors of the respective words contained in the second corpus; and
changing the word embedding vectors of the respective words contained in the second corpus based on the determined correspondence so as to rearrange elements of the word embedding vectors of the respective words contained in the second corpus.

2. The word embedding vector integration apparatus according to claim 1, wherein the first corpus and the second corpus differ from each other in language or domain.

3. The word embedding vector integration apparatus according to claim 1, wherein by presenting words related to the basis vectors corresponding to the word embedding vectors of the respective words contained in the first corpus and words related to the basis vectors corresponding to the word embedding vectors of the respective words contained in the second corpus, and
the circuitry further configured to execute a method comprising: accepting input of the correspondence.

4. The word embedding vector integration apparatus according to claim 1, the circuitry further configured to execute a method comprising, when there is any word common to the first corpus and the second corpus, using a mean vector of the word embedding vector of the word in the first corpus and the changed word embedding vector of the word in the second corpus as a word embedding vector of the word.

5. A computer-implemented method for integrating a word embedding vector, comprising:
determining correspondence between basis vectors obtained from word embedding vectors of respective words generated from a first corpus and contained in the first corpus,
each of the basis vectors being made up of a value of a same element of the word embedding vectors of the respective words, and basis vectors obtained from word embedding vectors of respective words generated from a second corpus different from the first corpus and contained in the second corpus, each of the basis vectors being made up of a value of a same element of the word embedding vectors of the respective words, the correspondence being determined based on the word embedding vectors of the respective words contained in the first corpus and on the word embedding vectors of the respective words contained in the second corpus; and
changing the word embedding vectors of the respective words contained in the second corpus based on the determined correspondence so as to rearrange elements of the word embedding vectors of the respective words contained in the second corpus.

6. A computer-readable non-transitory recording medium storing computer-executable program instructions that when executed by a processor cause a computer system to execute a method comprising:
determining correspondence between basis vectors obtained from word embedding vectors of respective words generated from a first corpus and contained in the first corpus,
each of the basis vectors being made up of a value of a same element of the word embedding vectors of the respective words, and basis vectors obtained from word embedding vectors of respective words generated from a second corpus different from the first corpus and contained in the second corpus, each of the basis vectors being made up of a value of a same element of the word embedding vectors of the respective words, the correspondence being determined based on the word embedding vectors of the respective words contained in the first corpus and on the word embedding vectors of the respective words contained in the second corpus; and
changing the word embedding vectors of the respective words contained in the second corpus based on the determined correspondence so as to rearrange elements of the word embedding vectors of the respective words contained in the second corpus.

7. The word embedding vector integration apparatus according to claim 2, wherein by presenting words related to the basis vectors corresponding to the word embedding vectors of the respective words contained in the first corpus and words related to the basis vectors corresponding to the word embedding vectors of the respective words contained in the second corpus, and
the circuitry further configured to execute a method comprising: accepting input of the correspondence.

8. The word embedding vector integration apparatus according to claim 2, the circuitry further configured to execute a method comprising:
when there is any word common to the first corpus and the second corpus, using a mean vector of the word embedding vector of the word in the first corpus and the changed word embedding vector of the word in the second corpus as a word embedding vector of the word.

9. The word embedding vector integration apparatus according to claim 3, the circuitry further configured to execute a method comprising:
when there is any word common to the first corpus and the second corpus, using a mean vector of the word embedding vector of the word in the first corpus and the changed word embedding vector of the word in the second corpus as a word embedding vector of the word.

10. The computer-implemented method according to claim 5, wherein the first corpus and the second corpus differ from each other in language or domain.

11. The computer-implemented method according to claim 5, wherein by presenting words related to the basis vectors corresponding to the word embedding vectors of the respective words contained in the first corpus and words related to the basis vectors corresponding to the word embedding vectors of the respective words contained in the second corpus, and
the circuitry further configured to execute a method comprising: accepting input of the correspondence.

12. The computer-implemented method according to claim 5, the method further comprising: when there is any word common to the first corpus and the second corpus, using a mean vector of the word embedding vector of the word in the first corpus and the changed word embedding vector of the word in the second corpus as a word embedding vector of the word.

13. The computer-readable non-transitory recording medium according to claim 6, wherein the first corpus and the second corpus differ from each other in language or domain.

14. The computer-readable non-transitory recording medium according to claim 6, wherein by presenting words related to the basis vectors corresponding to the word embedding vectors of the respective words contained in the first corpus and words related to the basis vectors corresponding to the word embedding vectors of the respective words contained in the second corpus, and
the circuitry further configured to execute a method comprising: accepting input of the correspondence.

15. The computer-readable non-transitory recording medium according to claim 6, the circuitry further configured to execute a method comprising:
when there is any word common to the first corpus and the second corpus, using a mean vector of the word embedding vector of the word in the first corpus and the changed word embedding vector of the word in the second corpus as a word embedding vector of the word.

16. The computer-implemented method according to claim 10,
wherein by presenting words related to the basis vectors corresponding to the word embedding vectors of the respective words contained in the first corpus and words related to the basis vectors corresponding to the word embedding vectors of the respective words contained in the second corpus, and
the method further comprising:
accepting input of the correspondence.

17. The computer-implemented method according to claim 10, the method further comprising:
when there is any word common to the first corpus and the second corpus, using a mean vector of the word embedding vector of the word in the first corpus and the changed word embedding vector of the word in the second corpus as a word embedding vector of the word.

18. The computer-implemented method according to claim 11, the method further comprising:
when there is any word common to the first corpus and the second corpus, using a mean vector of the word embedding vector of the word in the first corpus and the changed word embedding vector of the word in the second corpus as a word embedding vector of the word.

19. The computer-readable non-transitory recording medium according to claim 13, wherein by presenting words related to the basis vectors corresponding to the word embedding vectors of the respective words contained in the first corpus and words related to the basis vectors corresponding to the word embedding vectors of the respective words contained in the second corpus, and
the circuitry further configured to execute a method comprising:
accepting input of the correspondence.

20. The computer-readable non-transitory recording medium according to claim 13,
when there is any word common to the first corpus and the second corpus, using a mean vector of the word embedding vector of the word in the first corpus and the changed word embedding vector of the word in the second corpus as a word embedding vector of the word.
